(19) United States
(12) Patent Application Publication
(10) Pub. No.: US 2014/0370166 A1
(43) Pub. Date: Dec. 18, 2014

(54) SYSTEM FOR THE APPLICATION OF ALKALINE SOLUTION TO DE-FEATHERED, PRE-CHILLED BIRDS

(71) Applicants: Mark Evan Vickery, Florence, AL (US); Stenen Blair McKinney, Florence, AL (US)

(72) Inventors: Mark Evan Vickery, Florence, AL (US); Stenen Blair McKinney, Florence, AL (US)

(21) Appl. No.: 14/304,899

(22) Filed: Jun. 14, 2014

Related U.S. Application Data
(60) Provisional application No. 61/835,824, filed on Jun. 17, 2013.

(51) Int. Cl. A23B 4/24

(52) U.S. Cl. CPC A23B 4/24; A23V 2002/00
USPC 426/231

(57) ABSTRACT

A method for the reduction of gram-negative bacteria on de-feathered, pre-chilled birds includes preparing an alkaline mixture comprising sodium hydroxide and at least one other component. The method further includes combining the alkaline mixture with a waterline creating an alkaline solution. The method further includes testing the alkaline solution for pH values. The method further includes determining if pH value is between approximately 9 and approximately 14. The method further includes exposing a de-feathered, pre-chilled bird carcass to the alkaline solution if the alkaline solution is between approximately 9 and approximately 14. The method further includes repeating the steps of combining of the alkaline mixture with the waterline and testing the alkaline solution for pH values, and then exposing a de-feathered, pre-chilled bird carcass to the alkaline solution if the alkaline solution is between approximately 9 and approximately 14.

### CROSS-REFERENCE TO RELATED APPLICATION

This application claims the benefit of U.S. provisional application Ser. No. 61/835,824, filed Jun. 17, 2013, the contents of which are herein incorporated by reference.

### BACKGROUND OF THE INVENTION

The present invention relates to poultry production and, more particularly, to a method for reducing gram-negative bacteria on de-feathered, pre-chilled bird carcasses.

A gram-negative bacterium is the most common cause of infectious bacterial enteritis, food poisoning, worldwide. There are two species in particular which cause human disease; Campylobacter jejuni and Campylobacter coli. Disease control studies have demonstrated that 50% to 70% of human Campylobacter infection is attributed to consuming poultry and poultry products. Campylobacteriosis is the infectious disease caused by the bacteria. Most people who become ill with campylobacteriosis get diarrhea, cramping, abdominal pain, and fever within two to five days after exposure to the organism. The diarrhea may be bloody and can be accompanied by nausea and vomiting. The illness typically lasts about one week. In persons with compromised immune systems, Campylobacter occasionally spreads to the bloodstream and may cause a serious life-threatening infection.

Campylobacter is one of the most common causes of diarrheal illness in the United States. Most cases occur as isolated, sporadic events, not as part of recognized outbreaks. Active surveillance through the Foodborne Diseases Active Surveillance Network (FoodNet) indicates that about 14 cases are diagnosed each year for each 100,000 persons in the population. Many more cases go undiagnosed or unreported, and campylobacteriosis is estimated to affect over 1.3 million persons every year. Campylobacteriosis occurs much more frequently in the summer months than in the winter. The organism is isolated from infants and young adults more frequently than from persons in other age groups and from males more frequently than females. Although Campylobacter infection does not commonly cause death, it has been estimated that approximately 76 persons with Campylobacter infections die each year. There has been increasing international concern at the rising incidence of Campylobacter infection worldwide, which displays a marked seasonality.

Other devices or systems rely on acids to address reduction of gram-negative bacteria. In order to be effective, pH must be substantially reduced. This reduction may cause tissue damage to the bird carcass, negatively impact the impingement points, and negatively alter the isoelectric point of the de-feathered, pre-chilled birds.

As can be seen, there is a need for a method for reducing gram-negative bacteria without negatively affecting the isoelectric point of the bird carcass and while positively impacting impingement points, aiding in the retention of fatty tissue, allowing for a collectively cleaner process, and reducing the organic load going into the chillers.

### SUMMARY OF THE INVENTION

In one aspect of the present invention, a method for the reduction of gram-negative bacteria on de-feathered, pre-chilled birds comprises: preparing an alkaline mixture comprising sodium hydroxide and at least one other component; combining the alkaline mixture with a waterline creating an alkaline solution; testing the alkaline solution for pH values; determining if pH value is between approximately 9 and approximately 14; and exposing a de-feathered, pre-chilled bird carcass to the alkaline solution if the pH value is between approximately 9 and approximately 14.

In another aspect of the present invention, the method further comprises: repeating the combining of the alkaline mixture with a waterline creating an alkaline solution; testing the alkaline solution for pH values if the first pH value is outside of approximately 9 and approximately 14; determining if pH value is between approximately 9 and approximately 14; and exposing a de-feathered, pre-chilled bird carcass to the alkaline solution if the pH value is between approximately 9 and approximately 14.

These and other features, aspects and advantages of the present invention will become better understood with reference to the following drawings, description and claims.

### BRIEF DESCRIPTION OF THE DRAWINGS

FIG. 1 is a flow chart of an exemplary embodiment of the present invention.

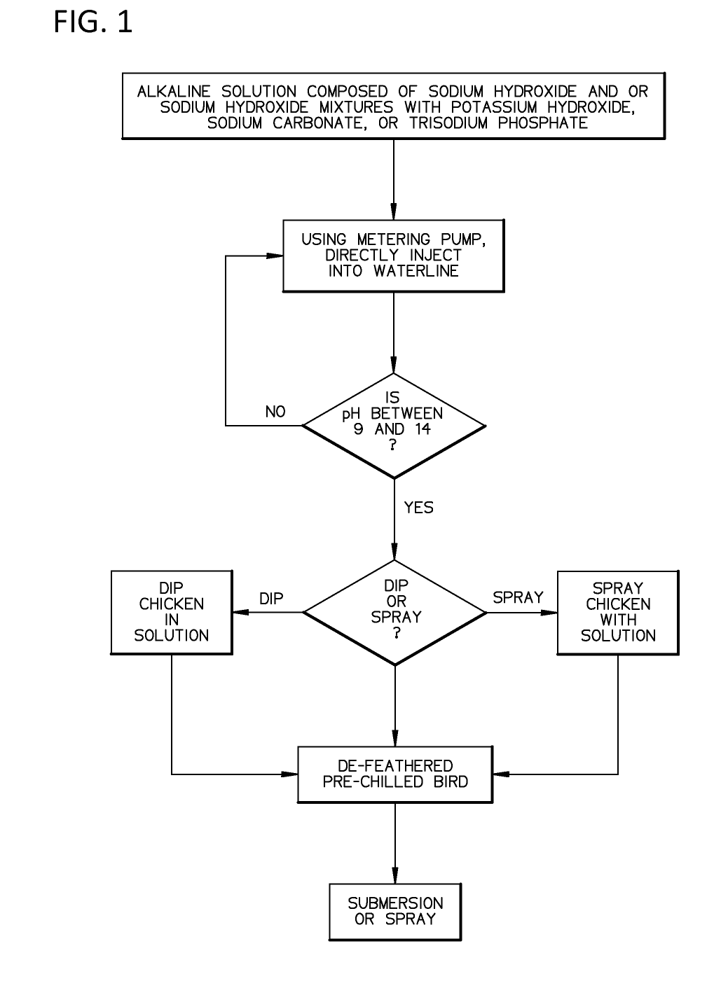

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method for the reduction of gram-negative bacteria on de-feathered, pre-chilled birds that includes preparing an alkaline mixture comprising sodium hydroxide and at least one other component. The method further includes combining the alkaline mixture with a waterline creating an alkaline solution. The method further includes testing the alkaline solution for pH values. The method further includes determining if pH value is between approximately 9 and approximately 14. The method further includes exposing a de-feathered, pre-chilled bird carcass to the alkaline solution if the alkaline solution is between approximately 9 and approximately 14. The method further includes repeating the steps of combining of the alkaline mixture with the waterline and testing the alkaline solution for pH values, and then exposing a de-feathered, pre-chilled bird carcass to the alkaline solution if the alkaline solution is between approximately 9 and approximately 14.

The present invention may allow for a reduction in gram-negative bacteria without negatively affecting the isoelectric point or the tissue of the bird carcass. The use of an alkaline solution as a dip, spray, or other application to a de-feathered bird in a pre-chilled environment may reduce the number of gram-negative bacteria by the process of alkaline lysis. The method may allow for the lysing of the cell wall of gram-negative bacteria, while maintaining an isoelectric point that favors solubility, therefore increasing moisture absorption for penetration in impingement points, which are typically areas of protection for gram-negative bacteria.

As is illustrated in the FIGURE, the present system may include the introduction of an alkaline mixture to a waterline with a temperature of approximately sixty degrees Fahrenheit or greater to produce an alkaline solution for exposing a pre-chilled, de-feathered bird carcass for the purposes of reducing gram-negative bacteria. The alkaline mixture may include sodium hydroxide and at least one other component. A pH probe, pH testing strips, or the like, may be used to determine if the pH of the solution is between approximately 9 and approximately 14. If the analysis yields a pH in a range between approximately 9 and approximately 14, the test may be deemed successful and the pre-chilled, de-feathered bird carcass may be exposed to the alkaline solution. If the analysis yields a pH lower than the range of between approximately 9 and approximately 14, the test may be deemed unsuccessful and additional amounts of the alkaline mixture may be directly injected into the waterline via a metering pump. The process of adding additional amounts of the alkaline mixture and testing may be repeated until the desired conditions may be achieved and then the bird carcass may be exposed to the solution. The alkaline solution may be either applied by placing the de-feathered, pre-chilled bird carcass in a dip tank or by spraying the de-feathered, pre-chilled bird carcass with the alkaline solution from a spray bar.

By following these steps, a method of exposing a de-feathered, pre-chilled bird carcass to an alkaline solution may be achieved in order to reduce the number of gram-negative bacteria, while not allowing the isoelectric point to be negatively affected or damaging the bird carcass tissue. In alternate embodiments an increase in the temperature of the water prior to solution may increase efficacy, but may require additional equipment to process.

In certain embodiments, the alkaline mixture may include sodium hydroxide and potassium hydroxide. In certain embodiments, the alkaline mixture may also include sodium carbonate. In certain embodiments, the alkaline mixture may also include trisodium phosphate. These other components may be introduced at varied concentrations to reduce the number of non-specific bacteria on a bird carcass. In certain embodiments the alkaline mixture may contain the ratio of approximately 3 parts sodium hydroxide to approximately 1 part of at least one other component.

The reduction of gram-negative bacteria on a de-feathered, pre-chilled bird carcass may be achieved by the following steps. The alkaline solution may be created by the introduction of the alkaline mixture injected into the waterline by a metering pump. The water for solution may be approximately sixty degrees Fahrenheit or greater. The pH of the solution may be tested using a pH probe, pH testing strips, or the like. When the pH of solution may be between approximately 9 and approximately 14, the bird carcass may be exposed to the solution via dip or spray. When the pH may be less than approximately 9, the test may be deemed a failure. Additional amounts of the alkaline mixture may be injected into the solution by the metering pump at this time. Once the additional amounts of the alkaline mixture may be injected, the pH of the solution may be tested again until the pH range may be within approximately 9 and approximately 14. The process of adding additional amounts of the alkaline mixture and testing may be repeated until the desired conditions may be achieved and then the de-feathered, pre-chilled bird carcass may be exposed to the solution via dip or spray. At the conclusion of exposure of the de-feathered, pre-chilled bird carcass to the alkaline solution, gram-negative bacteria may be reduced.

The present invention may expose the de-feathered, pre-chilled bird carcass to the alkaline solution in an optimal environment achieved by following the above-listed steps, to accomplish a reduction in gram-negative bacteria without negatively affecting the isoelectric point or the tissue of the bird carcass. Retention of fatty tissue may be aided by this method. A reduction in an organic load going into the chillers, which may allow for a collectively cleaner process, may be produced with this method.

It should be understood, of course, that the foregoing relates to exemplary embodiments of the invention and that modifications may be made without departing from the spirit and scope of the invention as set forth in the following claims.

What is claimed is:

1. A method for the reduction of gram-negative bacteria on de-feathered, pre-chilled birds comprising:
(a) preparing an alkaline mixture comprising sodium hydroxide and at least one other component;
(b) combining the alkaline mixture with a waterline creating an alkaline solution;
(c) testing the alkaline solution for pH values;
(d) determining if pH value is between approximately 9 and approximately 14; and
(e) exposing a de-feathered, pre-chilled bird carcass to the alkaline solution if step (d) is true.

2. The method of claim 1, wherein the waterline is heated to a temperature of at least approximately sixty degrees Fahrenheit before step (b).

3. The method of claim 1, wherein the alkaline mixture in step (a) comprises sodium hydroxide and potassium hydroxide.

4. The method of claim 3, wherein the alkaline mixture in step (a) further comprises sodium carbonate.

5. The method of claim 3, wherein the alkaline mixture in step (a) further comprises trisodium phosphate.

6. The method of claim 1, wherein the combination of the alkaline mixture and the waterline in step (c) is created by directly injecting the alkaline mixture of step (a) through a metering pump into the waterline.

7. The method of claim 1, wherein the exposure of the de-feathered, pre-chilled bird carcass in step (e) is by placing the de-feathered, pre-chilled bird carcass into a dip tank containing the alkaline solution within the pH value range between approximately 9 and approximately 14.

8. The method of claim 1, wherein the exposure of the de-feathered, pre-chilled bird carcass in step (e) is by spraying the de-feathered, pre-chilled bird carcass from a spray bar containing the alkaline solution within the pH value range between approximately 9 and approximately 14.

9. The method of claim 1, wherein the alkaline mixture in step (a) comprises the ratio of approximately 3 parts sodium hydroxide to approximately 1 part at least one other component.

10. The method of claim 1, further comprising:
(f) repeating steps (b) through (c) if step (d) is false;
(g) determining if pH value is between approximately 9 and approximately 14; and
(h) exposing a de-feathered, pre-chilled bird carcass to the alkaline solution if step (g) is true.
